(19) United States
(12) Patent Application Publication
(10) Pub. No.: US 2004/0075547 A1
(43) Pub. Date: Apr. 22, 2004

(54) Commandable covert surveillance system

(76) Inventors: George L. Vojtech, Centerville, MD (US); Daniel J. DeCicco, Pasadena, MD (US); Charles B. Cooperman, Highland, MD (US)

Correspondence Address: Francis A Cooch Office of Patent Counsel, The Johns Hopkins University, Applied Physics Laboratory, 11100 Johns Hopkins Road, Laurel, MD, 20723-6099, US

(21) Appl. No.: 10/466,458

(22) PCT Filed: Feb. 12, 2002
(86) PCT No.: PCT/US02/04177

(51) Int. Cl. G08B 23/00

(52) U.S. Cl. 340/500

(57) ABSTRACT

A general purpose surveillance system for remote surveillance applications. The system is comprised of one or more audio (e.g., microphone) or video (e.g., camera) surveillance devices that are wirelessly coupled with triggering devices. The system is capable of transmitting audio, video and still pictures via wireless transmission links. The wireless transmission links can be radio frequency (RF) links such as satellite up/down links and commercial cellular networks. Or, the wireless transmission links can be direct line of sight wireless communications such as infrared (IR). The system can be triggered to transmit audio and/or video data either remotely or internally. A variety of sensor types, including but not limited to, infrared sensors, motion sensors, acoustic sensors, magnetic sensors, or electric field sensors can act as a triggering mechanism.

### CROSS REFERENCE TO RELATED APPLICATIONS

This application is related to and claims the benefit of U.S. Provisional Patent Application Serial No. 60/268,067, filed Feb. 12, 2001 entitled “Commandable Covert Autonomous Surveillance Sensors”.

### FIELD OF THE INVENTION

The present invention is related to a covert remotely controllable surveillance system.

### BACKGROUND

Video and audio surveillance have proven to be useful tools in crime prevention, law enforcement, and intelligence gathering. Traditionally, surveillance sensors have been permanently installed, require a wired power supply and rely on local recorders or closed-circuit networks.

What is needed is a surveillance system that is independent of local infrastructure for power, connection, and control. By using battery power and remote wireless connections, the present invention may be placed in nearly any environment. Global connectivity options extend the operational area world-wide. An option to include GPS information allows the exact position of the device to be known. A triggering device that responds only to certain stimuli is applied to make best use of the available battery power and connection bandwidth. The use of a remote wireless triggering device allows the surveillance device to be placed at a distance from the monitored area, increasing its “covertness”. Triggers that respond to different stimuli may be used with the same surveillance unit, and placed accordingly. The present invention also provides a means to adjust the operational parameters, such as trigger sensitivity, audio gain, or camera position to simplify the employment of surveillance devices and to allow for changes in environmental characteristics or operational requirements.

### SUMMARY

The present invention is a wireless surveillance system for remote surveillance applications. The system is comprised of one or more audio (e.g., microphone) and/or video (e.g., camera) surveillance devices that are wirelessly coupled with triggering devices and remote computers. The system is capable of transmitting audio, video and still pictures via wireless transmission links. The wireless transmission links can be radio frequency (RF) links such as satellite up/down links or commercial cellular networks. Or, the wireless transmission links can be direct line of sight wireless communications such as infrared (IR) and the like.

The system is triggered to transmit audio and/or video data via a variety of sensor types, including but not limited to, infrared sensors, motion sensors, acoustic sensors, magnetic sensors, or electric field sensors. The system can also be controlled and configured via a wireless link with a remote processing device such as a computer. Operations including power control, trigger parameter configuration, surveillance device parameter configuration, and redefinition of the transmitted data set can be achieved remotely.

The system is designed to be installed covertly or into camouflaged assemblies. Additional features can include Global Positioning System (GPS) capability, local data storage and a low-power mode operation. The receiver for this system can be a remote processing device having audio and video output connectivity. Or, for field applications, the system receiver can be a covert A/V receiver including audio and video reception and playback integrated into a portable playback device such as a custom eyeglass design, personal digital assistant (PDA), or the like.

### BRIEF DESCRIPTION OF THE DRAWINGS

FIG. 1 illustrates a block diagram of the components that comprise the present invention.

FIG. 2 is a block diagram of one possible RF embodiment for a trigger transmitter device.

FIG. 3 is a block diagram of one possible RF embodiment for a trigger receiver device.

FIG. 4 illustrates a flowchart of system operation.

### DETAILED DESCRIPTION

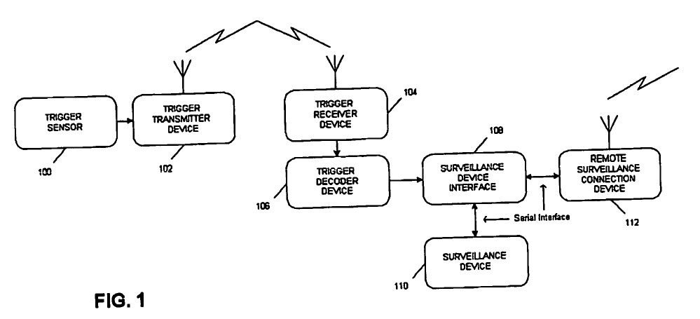

FIG. 1 illustrates a block diagram of the system that comprises the present invention. A single trigger sensor 100 or multiple trigger sensors 100 are strategically positioned throughout an area targeted for covert surveillance. There are a variety of trigger sensor types that can be employed. The types of trigger sensors can be chosen arbitrarily or according to the environmental conditions of the area targeted for surveillance. Sensor types include, but are not limited to, motion sensors, infrared sensors, magnetic sensors, electric field sensors, and acoustic sensors. The term trigger sensor refers to a means for activating a surveillance system upon detection of a specific signal from the sensor.

Detection of a triggering event by a trigger sensor 100 causes a reaction in a trigger transmitter device 102 that is coupled with the trigger sensor 100. A trigger transmitter device 102 is a wireless transmission device that is responsible for sending a signal, preferably a coded signal, to a trigger receiver device 104. The signal contains information that, when decoded by a trigger decoder device 106 coupled with the trigger receiver device 104, causes a surveillance device 110 to be activated. The trigger receiver device 104 is wirelessly coupled with the trigger transmitter device 102. The wireless connection between the trigger transmitter device 102 and the trigger receiver device 104 can be, among other connections, an RF connection or an infrared connection.

Once the signal from the trigger decoder device is decoded it is passed to a surveillance device interface 108. The surveillance device interface 108 is responsible for controlling the actual surveillance device 110 be it an audio device, a video device or both. The surveillance device 110 may be equipped with internal storage that can record as well as relay surveillance data. The trigger sensor 100 indirectly initiates activation of the surveillance device 110 but a remote surveillance connection device 112 is responsible for controlling the surveillance device 110 and obtaining data from the surveillance device 110. The surveillance device 110 is directly wired to the remote surveillance connection device 112. The remote surveillance connection device 112 also employs a wireless connection to a remote device such as a computer (not shown). The remote computer can send command data to the surveillance device 110 via the remote surveillance connection device 112 and can receive observed data from the surveillance device 110 via the remote surveillance connection device 112. Command data can include commands that affect the parameters of a surveillance device 110. For instance, if the surveillance device is a audio/video device such as a camera with a microphone, parameters can include microphone sensitivity, image size, image compression ratio, as well as image pan, tilt, and zoom controls.

The wireless connection between the remote surveillance connection device 112 and a remote computer typically covers a much greater distance than the wireless connection between the trigger transmitter device 102 and the trigger receiver device 104. The latter connection can utilize short distance low power radio frequency (RF) or infrared (IR) wireless communications. The former connection, however, typically uses a higher power wireless RF connection scheme that may involve a cellular phone network or a satellite up/down link. One advantage to using a cellular network or a satellite connection is the ability to interface with traditional wireline communication systems such as, for instance, the Public Switching Telephone Network (PSTN) or a cable television network. This allows for Inter/Intra-net connectivity or a point-to-point connection between a surveillance device 110 and a remote computer.

Some surveillance operations may desire surveillance data to be sent discretely to a party that is within or near the area under surveillance. For such close operations an audio/visual receiving device may be discretely integrated into a pair of eyeglasses or a personal digital assistant (PDA) such as a Palm Pilot>. Such a device would allow one to view and listen to targeted subjects without arousing suspicion. In this example, the remote surveillance connection device 112 transmits surveillance data to the eyeglass or PDA device. The remote surveillance connection device 112 can still be controlled by the remote computer, however.

In another example, some surveillance operations may desire global positioning system (GPS) functionality. GPS is a system utilizing multiple satellites to determine the position of a GPS device at any given moment. Positional information can be valuable especially in a mobile surveillance scenario. Position information can be used for targeting or mapping applications. In such applications the surveillance device can be equipped with a GPS device such that it can be remotely tracked by a GPS tracking device.

System control commands can be sent over the wireless connection between the remote computer and the remote surveillance connection device 112. These commands are then forwarded to the surveillance device interface 108 and onto the surveillance device 110 via a serial or other type of connection. The commands can include, zooming, panning, and tilting of a camera. The commands can also include sensitivity adjustments to the surveillance device 110 as well as power on and off and a data erase function. A serial connection between the remote surveillance connection device 112 and the surveillance device interface 108 has been illustrated in FIG. 1. A similar serial connection between the surveillance device interface 108 and the actual surveillance device 110 has also been illustrated in FIG. 1. Use of a serial connection is but one example of a coupling among the respective devices. A serial connection is a ubiquitous computer interface that provides a suitable connection. The present invention, however, can be implemented using other couplings for connecting the remote surveillance connection device 112, the surveillance device interface 108, and the actual surveillance device 110.

One example of a trigger sensor 100 suitable for use with the present invention is a pyroelectric infra-red (PIR) motion sensor system, similar to those used in motion sensitive lighting applications. A PIR motion sensor device can sense motion within a 40-foot range. Upon sensing motion, a relay is energized which is used to activate the trigger transmitter device 102.

Other trigger devices that can be implemented for use in the present invention include, but are not limited to, a simple micro-switch activator, a low-power 1/3 octave filter acoustic sensor, and optical “trip-wire” sensors. The required output from each of these sensors is a relay that energizes the trigger transmitter device 102. The sensor output relay can be either an electromechanical relay or a semiconductor relay for low-power operation.

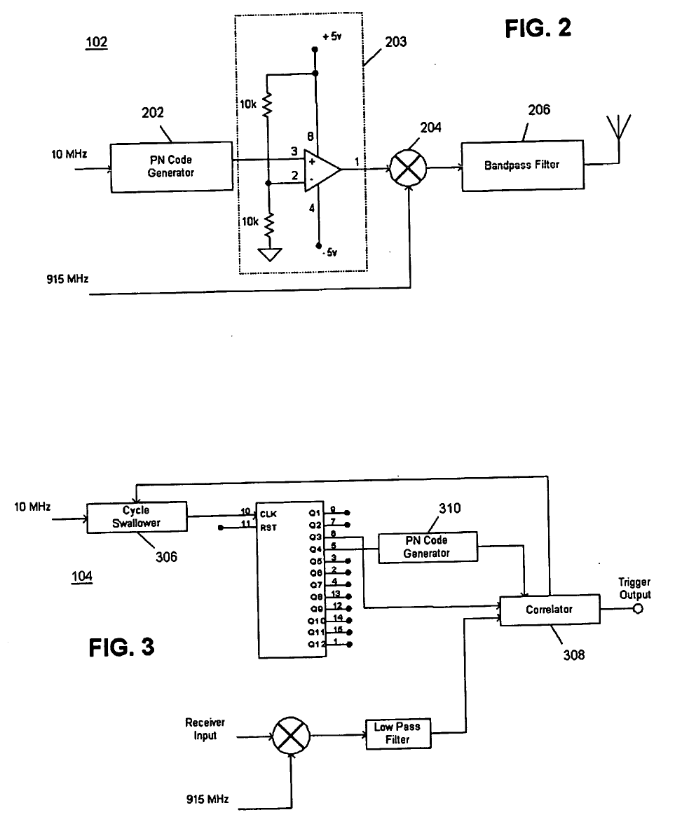

FIG. 2 is a block diagram of one possible RF embodiment for a trigger transmitter device 102. The RF trigger transmitter device 102 of FIG. 2 utilizes a direct sequence spread spectrum (DSSS) multiple access method to provide a low probability of detection, improved noise immunity, and the ability to collocate multiple surveillance device/trigger systems without interference. The trigger transmitter device 102 is activated by the application of power as a result of the energizing of the sensor output relay in trigger sensor 100.

This trigger transmitter device 102 is comprised of three subsystems including a pseudo-noise (PN) code generator 202, a level shifter 203, an RF mixer 204, and a bandpass filter 206. The PN code generator 202 is capable of generating a PN sequence of length 1 to 15 bits. The trigger transmitter device PN code is set to match that of the trigger receiver device 104 to de-spread the received signal. The level shifter circuitry 203 is used to translate the unipolar PN code data into a bipolar signal which can be used to generate a binary phase-shift-keyed (BPSK) signal out of the RF mixer 204.

To accommodate multiple sensor types and allow for component count minimization, the trigger transmitter device 102 can alternatively be activated/deactivated by controlling the CL line on a clocking circuit (not shown) that drives the PN code generator 202.

One embodiment of a trigger receiver/decoder device 104, 106 is illustrated in FIG. 3. As in the trigger transmitter device 102, the mixer and oscillator (not shown) within the trigger receiver device 104 can be any of a number of components, including the same components as those used in the trigger transmitter device 102. The trigger receiver device 104 uses a “cycle swallower” circuit 306 as the DSSS tracking technique. The cycle swallower 306 synchronizes the incoming PN code with the locally generated PN code.

FIG. 3 encompasses both the trigger receiver and trigger decoder blocks illustrated in FIG. 1. All components to the left of correlator 308 comprise the receiver functionality while the correlator 308 acts as the decoder. A PN code generator 310 generates a local PN code that acts as a key for the received PN code such that correlator 308 generates an output only when the received and local PN codes match.

In one embodiment, the surveillance device interface 108 can support virtually any surveillance device 110 that communicates over a serial data link. This permits the surveillance device 110 to be operated remotely using serial data from the remote surveillance connection device 112 which can be received from, for instance, a cellular or satellite phone network

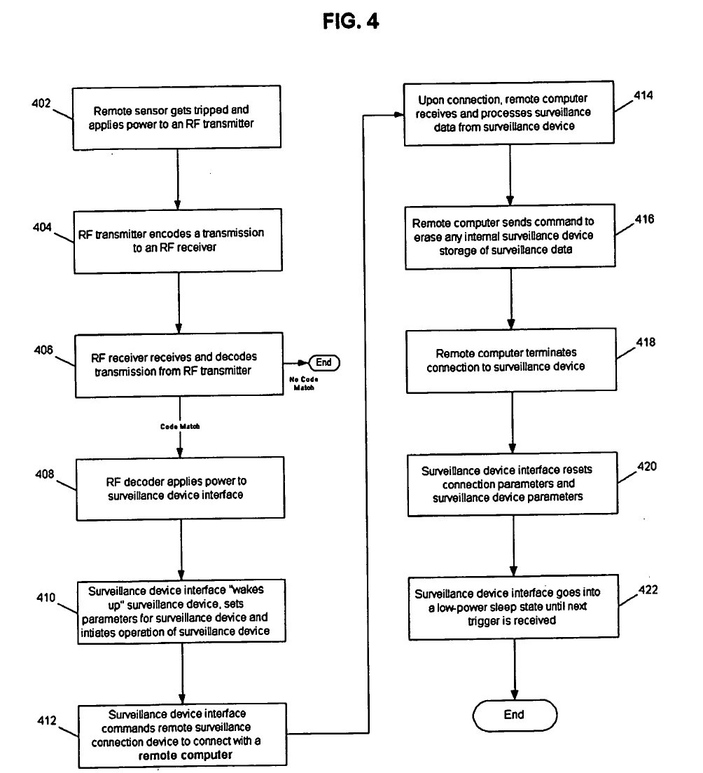

The present invention is programmable and controllable by software. FIG. 4 illustrates a flowchart of system operation for one embodiment of the present invention. Those of ordinary skill in the art can make modifications to the circuit parameters of the components of the present invention without departing from the spirit or scope of the present invention. Thus, the values used to describe the operation of the present invention are illustrative only and are not intended to limit the present invention.

A remote sensor (e.g., switch closure, light level change, trip wire, sonic sensor, etc.) applies power 402 to a pulse-coded RF transmitter. The RF transmitter then encodes 404 a transmission to be sent to an RF receiver. The RF receiver receives and decodes 406 the pulse train from the RF transmitter. If there is a code match, then a pulse is applied 408 to a trigger input on a surveillance device interface. The surveillance device interface “wakes up” a surveillance device, sets the surveillance device parameters, and commands the surveillance device to operate 410. The surveillance device interface also commands a remote surveillance connection device to dial a modem or otherwise establish a connection 412 with a remote computer. Upon establishment of a connection with the remote computer, the surveillance device sends and the remote computer receives surveillance data from the surveillance device 414. The remote computer can optionally send a command to erase 416 any internal storage of surveillance data residing in the surveillance device. When the remote computer wishes to terminate the surveillance operation it can terminate 418 its connection to the surveillance device. Upon termination of its connection with the remote computer, the surveillance device interface resets the connection parameters and the surveillance device parameters 420. In addition, the surveillance device interface goes into a low-power sleep state 422 until the next time it is fully powered up due to a tripped sensor.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of surveillance comprising:
detecting when a sensor has been triggered by an external event;
sending a first wireless signal from a transmitter device that is coupled with said sensor after said sensor has detected said external event;
receiving said first wireless signal in a receiver device;
activating a surveillance device that is coupled with said receiver device as a result of receiving said first wireless signal;
establishing connection between said surveillance device and a remote computer via a second wireless signal upon activation of said surveillance device; and
wirelessly sending surveillance data observed by said surveillance device to said remote computer via the connection between said surveillance device and said remote computer.

2. The method of claim 1 further comprising:
encoding said first wireless signal before sending; and
activating said surveillance device only when said first wireless signal has been successfully decoded.

3. The method of claim 2 wherein the first wireless signal is encoded and decoded using a direct sequence spread spectrum (DSSS) coding scheme.

4. The method of claim 1 further comprising storing observed surveillance data within said surveillance device.

5. The method of claim 1 further comprising:
sending a command from said remote computer to said surveillance device, said command for manipulating said surveillance device;
receiving said command in said surveillance device for manipulating said surveillance device; and
manipulating said surveillance device according to the command.

6. The method of claim 4 further comprising:
sending a command from said remote computer to said surveillance device, said command for erasing said stored surveillance data within said surveillance device upon said remote computer receiving said surveillance data from said surveillance device;
receiving said command in said surveillance device for erasing said stored surveillance data within said surveillance device; and erasing said stored surveillance data within said surveillance device.

7. The method of claim 1 further comprising:
sending a command from said remote computer to said surveillance device, said command for adjusting the parameters of said surveillance device;
receiving said command in said surveillance device for adjusting the parameters of said surveillance device; and
adjusting the parameters of said surveillance device.

8. The method of claim 7 wherein said parameters of said surveillance device include microphone sensitivity.

9. The method of claim 7 wherein said parameters of said surveillance device include image size.

10. The method of claim 7 wherein said parameters of said surveillance device include image compression ratio.

11. The method of claim 7 wherein said parameters of said surveillance device include image pan.

12. The method of claim 7 wherein said parameters of said surveillance device include image tilt.

13. The method of claim 7 wherein said parameters of said surveillance device include image zoom.

14. The method of claim 1 further comprising:
terminating the connection between said surveillance device and said remote computer;
resetting connection parameters between said surveillance device and said remote computer upon termination of said connection; and
resetting surveillance device parameters upon termination of said connection.

15. The method of claim 14 further comprising placing said surveillance device into a low-power sleep state until it is activated again.

16. A surveillance system comprising:
a sensor;
a wireless transmitter device coupled with said sensor;
a receiver device;
a surveillance device interface coupled with said receiver;
a surveillance device coupled with said surveillance device interface; and
a remote surveillance connection device coupled with said surveillance device interface,
wherein when said sensor is triggered a first wireless signal is sent from said wireless transmitter device to said receiver device causing a second signal to be sent to said surveillance device interface, said second signal for activating said surveillance device and also for causing said remote surveillance connection device to establish a wireless connection with a remote computer such that surveillance data observed by said surveillance device is sent, via said wireless connection, to said remote computer via said surveillance device interface and said remote surveillance connection device.

17. The system of claim 16 wherein the wireless transmitter device encodes the first wireless signal prior to sending and said receiver device includes a decoder for decoding the encoded first wireless signal.

18. The system of claim 17 wherein the encoding and decoding of the first wireless signal is achieved using a direct sequence spread spectrum (DSSS) scheme.

19. The system of claim 16 wherein said sensor is a motion detector.

20. The system of claim 16 wherein said sensor is an acoustic sensor.

21. The system of claim 16 wherein said sensor is an optical trip-wire.

22. The system of claim 16 wherein said surveillance device is an audio only device.

23. The system of claim 16 wherein said surveillance device is a video only device.

24. The system of claim 16 wherein said surveillance device is a combination audio and video device.

25. The system of claim 16 wherein said surveillance device further comprises a GPS device such that the position of said surveillance device can be remotely tracked via a GPS tracking device.

26. The system of claim 16 wherein said wireless transmitter device is energized via an output relay from said sensor wherein said output relay is an electromechanical relay.

27. The system of claim 16 wherein said wireless transmitter device is energized via an output relay from said sensor wherein said output relay is a semiconductor relay.

28. The system of claim 16 wherein said surveillance device stores surveillance data internally.

29. The system of claim 16 wherein said remote surveillance connection device receives commands from said remote computer for the purpose of manipulating said surveillance device.

30. The system of claim 29 wherein said commands to manipulate said surveillance device include erasing stored surveillance data on said surveillance device.

31. The system of claim 29 wherein said commands to manipulate said surveillance device include the ability to configure the parameters of said surveillance device.

32. The system of claim 16 further comprising:
terminating the connection between said surveillance device interface and said remote computer;
resetting connection parameters between said surveillance device interface and said remote computer upon termination of said connection; and resetting surveillance device parameters upon termination of said connection.

33. The system of claim 32 further comprising placing said surveillance device and said surveillance device interface into a low-power sleep state until the next activation.

34. A system for surveillance comprising:
means for detecting when a sensor has been triggered;
means for sending a first wireless signal from a transmitter device that is coupled with said sensor after said sensor has been triggered;
means for receiving said first wireless signal in a receiver device;
means for activating a surveillance device that is coupled with said receiver device as a result of receiving said first wireless signal;
means for establishing a bidirectional connection between said surveillance device and a remote computer via a second wireless signal upon activation of said surveillance device; and
means for wirelessly sending surveillance data observed by said surveillance device to said remote computer via the connection between said surveillance device and said remote computer.

35. The system of claim 34 further comprising:
means for encoding said first wireless signal before sending; and
means for activating said surveillance device only when said first wireless signal has been successfully decoded.

36. The system of claim 34 wherein the first wireless signal is encoded and decoded using a direct sequence spread spectrum (DSSS) coding scheme.

37. The system of claim 34 further comprising means for storing observed surveillance data within said surveillance device.

38. The system of claim 34 further comprising:
means for sending a command from said remote computer to said surveillance device, said command for manipulating said surveillance device;
means for receiving said command in said surveillance device for manipulating said surveillance device; and
means for manipulating said surveillance device according to the command.

39. The system of claim 34 further comprising:
means for sending a command from said remote computer to said surveillance device, said command for erasing said stored surveillance data within said surveillance device upon said remote computer receiving said surveillance data from said surveillance device;
means for receiving said command in said surveillance device for erasing said stored surveillance data within said surveillance device; and
means for erasing said stored surveillance data within said surveillance device.

40. The system of claim 34 further comprising:
means for sending a command from said remote computer to said surveillance device, said command for adjusting the parameters of said surveillance device;
means for receiving said command in said surveillance device for adjusting the parameters of said surveillance device; and
means for adjusting the parameters of said surveillance device.

41. The system of claim 40 wherein said parameters of said surveillance device include microphone sensitivity.

42. The system of claim 40 wherein said parameters of said surveillance device include image size.

43. The system of claim 40 wherein said parameters of said surveillance device include image compression ratio.

44. The system of claim 40 wherein said parameters of said surveillance device include image pan.

45. The system of claim 40 wherein said parameters of said surveillance device include image tilt.

46. The system of claim 40 wherein said parameters of said surveillance device include image zoom.

47. The system of claim 34 further comprising:
means for terminating the connection between said surveillance device and said remote computer;
means for resetting connection parameters between said surveillance device and said remote computer upon termination of said connection; and
resetting surveillance device parameters upon termination of said connection.

48. The system of claim 47 further comprising means for placing said surveillance device into a low-power sleep state until it is activated again.
